(19) United States
(12) Patent Application Publication
(10) Pub. No.: US 2013/0226733 A1
(43) Pub. Date: Aug. 29, 2013

(54) Content Platform Enabling Content Distribution Through Virtual Goods

(71) Applicants: Ari Alan Evans, San Francisco, CA (US); Bryant Nathaniel Williams, Los Angeles, CA (US)

(72) Inventors: Ari Alan Evans, San Francisco, CA (US); Bryant Nathaniel Williams, Los Angeles, CA (US)

(21) Appl. No.: 13/406,404

(22) Filed: Feb. 27, 2012

(51) Int. Cl. G06Q 30/06

(52) U.S. Cl. 705/26.25

(57) ABSTRACT

Approaches for distributing content produced from a plurality of creative entities by way of collectable virtual goods. At a content platform, tiered pricing data that defines for each of a plurality of content producers a sequence of tiers is stored. Each tier may be associated with a different price and a particular number of virtual goods. The content platform may identify a next available virtual good for purchase from a particular content provider based on how many virtual goods associated with the particular content provider have already been purchased. The visual appearance of the virtual good may be based upon how many virtual goods of the content producer have already been purchased. Upon receiving payment for the virtual good, the content platform provides ownership of the virtual good to the purchaser to entitle the purchaser to receive restricted content provided by the content producer associated with the virtual good.

### FIELD OF THE INVENTION

Embodiments of the invention relate to a content platform for distributing content produced from a plurality of creative entities by way of collectable virtual goods.

### BACKGROUND

Creative entities, such as artists, musicians, and authors, often seek new ways to harness technology to connect with their supporters and fan base. A common mechanism for doing so is a web site. An artist may host a web site that contains content about the artist, such as tour dates, information about the artist's work, and audio or video clips of the artist's performances. An artist may choose to make certain content on their web site inaccessible unless a fee is tendered to gain access to the restricted area of the web site. In addition to any monetary incentive, the artist may wish to restrict access to certain content to only a portion of their audience. However, many users may be disinclined to pay a fee simply to view certain web pages of a web site.

As another example, an artist may use a social media service, such as Facebook or Twitter, to communicate with a large audience. The artist may post information and/or links to content using various social media services. If a user wishes to learn more about or interact with the particular artist, the user may follow the artist on Facebook or Twitter. Such social media forums, while useful in certain respects, have their limitations. Consequently, new mechanisms for cultivating relationships between creative entities and their supporters are desirable.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of an illustrative system according to an embodiment of the invention;

FIG. 2 is a flow chart illustrating the steps of accessing restricted content using a virtual good according to an embodiment of the invention;

FIGS. 3A-3C are illustrations of exemplary virtual goods according to embodiments of the invention; and

FIG. 4 is a block diagram that illustrates a computer system upon which an embodiment of the invention may be implemented.

### DETAILED DESCRIPTION OF THE INVENTION

Approaches for a content platform that makes available for purchase collectable virtual goods are presented herein. The collectible virtual goods may be prominently displayed in a variety of digital forums, such as a web site or within an application. The visual appearance of each collectible virtual good is unique and reflects how many other collectible virtual goods associated with a particular create entity were previously purchased. In addition to being a collectable item, the virtual good may provide certain benefits, such as access to restricted content.

In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

Embodiments of the invention are directed towards cultivating the relationship between a creative entity and fans of the creative entity. As broadly used herein, a creative entity refers to an individual, a group, or any type of entity which may produce or represent one or more creative endeavors. Non-limiting, illustrative examples of creative entities include an artist of any type (such as a musician, painter, performer, actor, or public speaker), a television or movie studio, an athlete or athletic group, a politician, a celebrity, a business, a brand, or any other entity which may produces or represents original content. A creative entity may be referred to herein as a content producer.

In an embodiment, a user may express their interest and/or support of a creative entity by “signing” the creative entity. The act of “signing” a creative entity involves using a user interface to indicate interest and/or support of the creative entity. In return for signing the creative entity, the user receives a collectible virtual good as a representation of their support and/or interest.

The collectible virtual good may be embodied in a variety of different ways. The virtual good may be a badge which the user may display on a web page or other type of graphical interface. A badge may be stylized uniquely for each creative entity so that each badge's appearance represents or is associated with the creative entity. In addition, a particular badge associated with a particular creative entity may also provide an indication of how many other badges associated with the particular creative entity where purchased prior to it being purchased. To illustrate, each badge may be individually numbered, so that the first user to sign a creative entity receives a badge displaying the number “1,” the second user to sign the same creative entity receives a badge displaying the number “2,” and so on.

Having ownership of a collectible virtual good, such as a badge, entitles the owner to have access to any premium (or “restricted”) content of the creative entity associated with the virtual good. A creative entity may make such premium content available online, such as through one or more web pages hosted by or associated with a content platform according to an embodiment. Alternately or additionally, a creative entity may decide that the premium content may include a real-world component, such as access to a particular section at a live concert.

Before discussing the operation of the invention in greater detail, a description of an illustrative system shall be presented.

### System Architecture

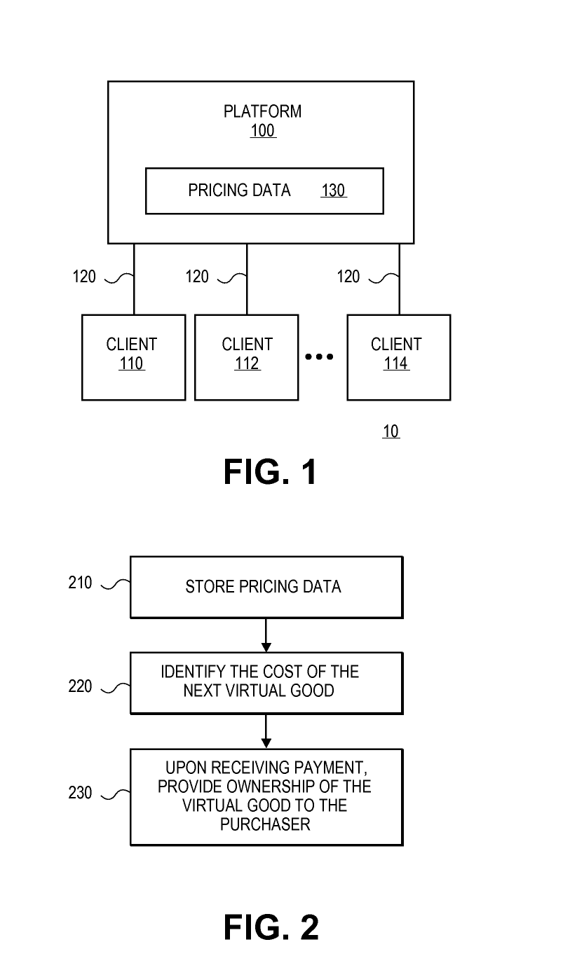

FIG. 1 is a block diagram of an illustrative system 10 according to an embodiment of the invention. System 10 may be used to make available for purchase collectable virtual goods according to an embodiment. As depicted in FIG. 1, system 10 includes content platform 100, clients 110, 112, and 114, and communications link 120.

Content platform 100 (or simply “platform 100”) represents one or more devices configured to make available for purchase virtual goods by users using a client. Platform 100 may be implemented as a single server that executes software configured to perform the actions attributed to platform 100 described herein. Alternately, for scalability and/or fault-tolerance purposes, platform 100 may be implemented using two or more different computers that operate as a functional unit, such as a cluster or grid of computers.

FIG. 1 depicts three clients, namely clients 110, 112, and 114. The term client refers to any component (typically software being executed by a hardware device) which allows a user to interact with platform 100. Non-limiting, illustrative examples of a client include a web page displayed on a PC or a hand-held device (such as a phone, tablet PC, or personal digital assistant), an application executing on a PC or a hand-held device, or any other combination of hardware/software which may be used to communicate with platform 100. While FIG. 1 depicts three clients for purposes of providing a clear example, embodiments of the invention may support any number of clients. Indeed, it is contemplated that embodiments may support a large numbers of clients.

A user may use a client to interact with platform 110. To illustrate, a user may use client 112 (embodied as web browser executing on a tablet PC) to view a web page associated with platform 100 or a user may use client 114 (embodied as an application executing on a cell phone) to interact with platform 100 over communications link 130. Clients may be, but need not be, implemented by or displayed on a wide variety of mobile devices.

Clients may interact with platform 100 over communications link 130. Communications link 130 is intended to broadly refer to any communications medium capable of enabling digital communication, such as a wireless network, a wired network, the Internet, and a direct physical connection (e.g., a USB port on platform 100).

### Accessing Restricted Content Using a Virtual Good

As used herein, any content produced by a creative entity in which ownership of a virtual good associated with the creative entity is required to access the content is referred to as restricted content or as premium content. Embodiments of the invention place no limitation on what could constitute restricted content, as restricted content may be embodied as digital content, as tangible, physical objects, or as privileges, rights, and/or licenses. Non-limiting, illustrative examples of restricted content include information about a creative entity, an application (or any portion thereof) provided by the creative entity, traditional media such as audio and video, early access to content an artist may not have released yet, ticket sales to an upcoming show, special access or privileges at live events, and live, web-streaming events.

In an embodiment, creative entities, or their authorized agents, are in full-control of determining the composition of their restricted content. A creative entity may display or distribute their restrictive content through a web site, or a portion thereof, hosted by or in communication with platform 100. As a creative entity may change the composition of their restrictive content at will, a creative entity has full control over updating any of their web pages hosted by platform 100. Creative entities may use a locking mechanism on any part of their web pages to require users to possess their virtual good in order to gain access thereto. The locking mechanism may be used to ensure that a creative entity's restrictive content is only accessible to those users who have purchased a virtual good from the creative entity. A creative entity, or their authorized agent, may update their restricted content and/or configure the locking mechanism using a user interface, such as a web page or an application.

FIG. 2 is a flow chart illustrating the steps of a user accessing restricted content using a virtual good according to an embodiment of the invention. Initially, before meaningful use of system 10 may take place by users, one or more creative entities should develop a strategy for using collectible virtual goods, and thereafter, store data that configures the operation of platform 100 to operate in accordance with that strategy. To that end, in step 210, pricing data is stored at a location at or accessible to content platform 100. In an embodiment, step 210 may be performed by storing pricing data 130 at platform 100 as depicted in FIG. 1. Alternately, pricing data 130 may be stored external to content platform 100 at a location that is accessible to content platform 100, such as a persistent storage medium accessible over a network connection.

Pricing data 130 may define, for one or more creative entities, a pricing structure for virtual goods for that creative entity. The pricing structure may be defined as a sequence of pricing tiers. Each pricing tier may be associated with a different price and a particular number of virtual goods. The purpose of the sequence of pricing tiers is to establish a pricing model that bases the price of a particular collectible virtual good upon when the particular collectible virtual good was purchased relative to the purchase of other virtual goods from the same creative entity.

For example, pricing data 130 for one creative entity may define a sequence of pricing tiers where the first 10 collective virtual goods purchased are free, the next 100 collective virtual goods purchased cost $0.50, the next 1000 collective virtual goods purchased cost $1.00, and thereafter all collectable virtual goods cost $2.00. Thus, this example comprises a sequence of four tiers, where the price of the collectible virtual good increases from $0 to $0.50 to $1 and finally to $2 based upon how many other collectible virtual goods of the creative entity have already been purchased.

As another example, pricing data 130 for another creative entity may define a sequence of pricing tiers where the first 1000 collective virtual goods purchased cost $1, the next 5000 collective virtual goods purchased cost $5, and thereafter all collectable virtual goods cost $8.00. Thus, this example comprises a sequence of three tiers, where the price of the collectible virtual good increases from $1 to $5 to $8 based upon how many other collectible virtual goods of the creative entity have already been purchased.

Embodiments of the invention place no limitation on what pricing plans may be described by pricing data 130. Thus, pricing data 130 may define pricing plans having any number of tiers. Further, each tier of a sequence of tiers defined by pricing data 130 may be associated with any cost.

After pricing data 130 is stored in platform 100, clients may interact with platform 100. As shall be described in additional detail below, a user may search platform 100 for certain collectible virtual goods that match the user's criteria. When a user finds a collectible virtual good that the user wishes to purchase, platform 100 will need to determine the cost associated with the virtual good. Also, if a user requests the display of a web page that includes one or more collectible virtual goods, then platform 100 may be configured to display the current price of those virtual goods. As a result, there are a variety of occasions when platform 100 may need to determine the current cost of a particular collectible virtual good. To that end, step 220 may be performed, as described below.

In step 220, the cost of a next available virtual good for a particular content provider is identified by platform 100. Platform 100 may determine the cost of a next available virtual good for a particular content provider by consulting pricing data 130. Determining the price of a particular virtual good may be based on how many virtual goods associated with the particular content provider have already been purchased. To illustrate, if exemplary pricing data describes a tiered pricing structure for a creative entity where the first 100 collectible virtual goods purchased cost $3, and the next available virtual good is the 57^{th} collectible virtual good purchased, then the cost of the next virtual good for that creative entity will be $3.

If the user wishes to purchase a collectible virtual good, then the user may submit payment for the collectible virtual good through the interface exposed by platform 100. For example, the user may use a client to submit payment through a web site. Alternately, the user could interact with platform 10 through an application executing on a cell phone or tablet PC, and so payment may be submitted to platform 100 through the application.

In step 230, upon receiving payment for a particular virtual good, content platform 100 provides ownership of the virtual good to the purchaser. Upon the purchaser receiving ownership of the virtual good, the purchaser is entitled to access the restricted content of the creative entity associated with the purchased virtual good. The purchaser may then display his or her virtual good using content platform 100.

There may be a variety of different ways for a purchaser of a virtual good to display the virtual good using content platform 100. A user could submit input to platform 100 to cause a web page or similar user interface to be displayed which depicts the collectible virtual goods which the user owns. In this way, the plurality of users which use system 10 may see all the collectible virtual goods that a particular user owns.

For example, platform 100 may host or be associated with a web site. The web site may allow each registered user to have a “user profile” web page. A user profile web page allows the user to display all the virtual goods that the user owns. Other web pages may allow the user to view the virtual goods owned by friends of the user.

As another example, a user may purchase virtual goods from platform 100 using an application executing on their cell phone or tablet PC. The application may notify other social media services, such as Facebook, Twitter, etc., of the virtual goods purchased by a user. In this way, the user may be able to notify his or her friends of the virtual goods which he or she has purchased. The user may be able to configure how much information is communicated in this fashion. If the user also wishes to make a recommendation to a set of friends who might also be interested in purchasing the virtual good, the user may be able to send a message, through the application or social media services in communication with the application, to other people to recommend the purchase of the virtual good.

### Visual Appearance of a Virtual Good

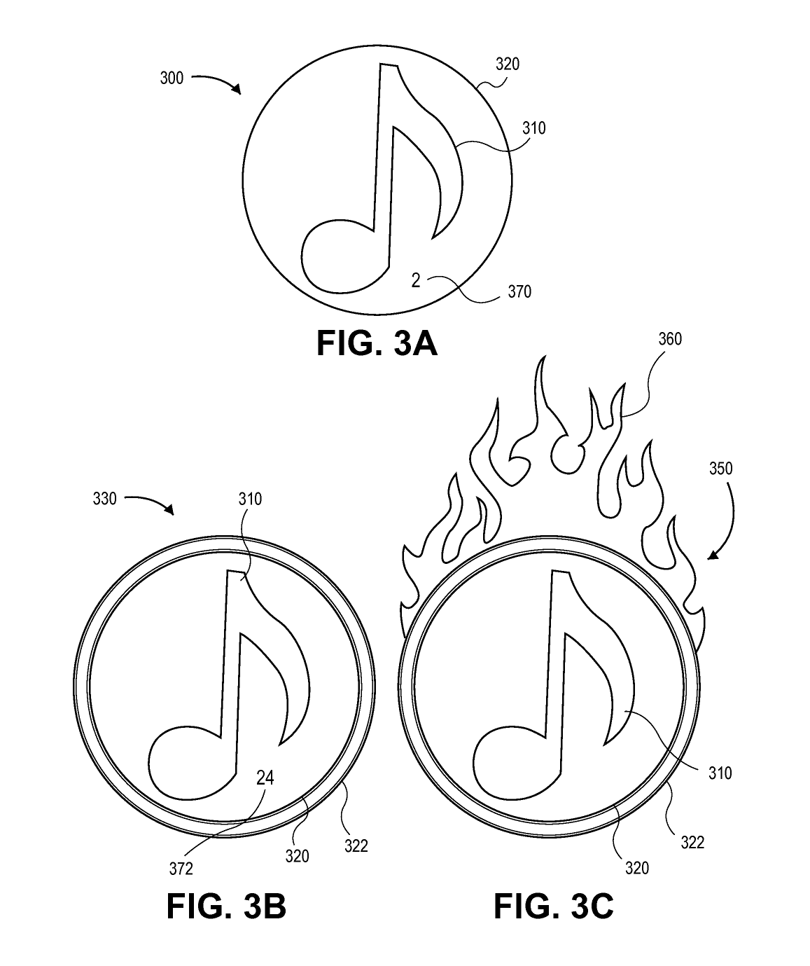

The visual appearance of the virtual good may be dynamically determined by platform 100 using a variety of factors. FIG. 3A is an illustration of an exemplary collectable virtual good 300 according to an embodiment of the invention. The collectable virtual good depicted in FIG. 3A is a badge.

Virtual good 300 comprises a graphic 310 and a circular border 320. Graphic 300 may be an image that is associated with a particular creative entity. The style, color, size, and overall visual appearance of graphic 300 may be indicative of, invoke, or otherwise represent the creative entity in which it represents. While not depicted in FIG. 3A, graphic 300 may have any amount of text depicted thereon and may be arbitrarily complex.

The visual appearance of the virtual good may also be based, at least in part, upon how many virtual goods of the content producer have already been purchased. To illustrate this point, consider FIG. 3B, which is an illustration of another exemplary collectable virtual good 330 according to an embodiment of the invention. Virtual good 330 of FIG. 3B looks similar to virtual good 300 of FIG. 3A, except that virtual good 330 comprises a second circular border 322. In an embodiment, portions of the appearance of a virtual good, such as a boarder, may be based under which tier of the pricing structure the virtual was purchased. For example, since virtual good 300 comprises a single boarder 320, then the appearance of virtual good 300 indicates it was purchased under the first tier of a pricing structure. Similarly, since virtual good 330 comprises second circular border 322, then the appearance of virtual good 330 indicates it was purchased under the second tier of a pricing structure. In this way, one would be able to visually distinguish between virtual goods of the same creative entity but purchased under different tiers of a pricing structure. Embodiments of the invention impose no restrictions on how to visually distinguish between virtual goods of the same creative entity but purchased under different tiers of a pricing structure. As a result, other embodiments of the invention need not solely distinguish in this regard based on the number of boarders, but alternately or additionally, may use a variety of other visual cues, such as color, shape, size, graphics, and text, to indicate under which tier of a pricing structure a particular virtual good was purchased.

The visual appearance of the virtual good may also include a number or other such visual identifier that represents how many other users, prior to the user, purchased a virtual good associated with the particular content producer. To illustrate, virtual good 300 depicts numerical label 370, which indicates that virtual good 300 is the second virtual good purchased from the particular content producer. As another example, virtual good 330 depicts numerical label 372, which indicates that virtual good 330 is the twenty-fourth virtual good purchased from the particular content producer.

The visual appearance of a virtual good may also depict movement according to an embodiment. To illustrate, consider FIG. 3C, which is an illustration of another exemplary collectable virtual good 350 according to an embodiment of the invention. The visual appearance of virtual good 350 includes fire 360, which is depicted as an animation so that the flames of fire 360 appear to be moving. Any graphical component of a virtual good may be rendered to have movement and/or change color. In an embodiment, virtual goods having animation may be deemed more desirable than virtual goods lacking animation, and as such, may be associated with lower tiers of a pricing structure (i.e., those associated with earlier purchasers of the virtual goods) defined by pricing data 130 than those virtual goods devoid of animation.

### Interacting with the Content Platform

A user may operate a client to interact with platform 100 to perform a variety of actions. A user may submit user input through a client to request that platform 100 display virtual goods that are associated with a creative entity having characteristics that match search criteria submitted by the user. In response to platform 100 receiving the search criteria from the user, platform 100 may cause a plurality of virtual goods associated with a creative entity having characteristics that match the search criteria submitted by the user to be displayed to the user. In this way, the user may search for creative entities and sign those that are of interest to the user.

As an aid to the user in discovering new creative entities, in an embodiment, platform 100 may analyze which virtual goods a particular user has purchased and may suggest additional virtual goods which may be of interest to the user. The user may submit input to platform 100 to cause platform 100 to display such recommendations to the user.

In an embodiment, platform 100 may allow a user to purchase a bundle of virtual goods as a single unit. For example, platform 100 may display, on a single web page or screen, a plurality of virtual goods which share a common characteristic. For example, a bundle of virtual goods associated with up and coming musicians in a particular geographical region may be offered. The user may then purchase all the virtual goods associated with the bundle in a single purchase.

Platform 100 may host or be in communication with a variety of different applications, social media services, and games. The virtual goods made available for purchase by platform 100 may be used, viewed in, and/or accessed in a variety of extended contexts. For example, platform 100 may either host or be in communication with an application that enables users to purchase virtual items in a simulated environment, such as in a simulation-type game (such as SimCity or Farmville) or in an online virtual world (such as Second Life). Platform 100 may only allow a user to purchase certain types of virtual goods (deemed second-type virtual goods) usable in such simulated environments after a user has purchased a collectible virtual good (deemed first-type virtual goods) associated with a creative entity. In this way, there is an added incentive to purchase a first-type virtual good from platform 100 as it enables a user to purchase a set of virtual goods in a different context, such as a simulation-type game or online virtual world. To provide a particular example, if a user purchases a first-type virtual good associated with a particular musician, then the user may have the option to purchase a T-shirt for his or her avatar in Second Life or a similar type game that displays the purchased first-type virtual good or related graphic.

### Pricing Models

Embodiments of the invention place no limitation on the types of pricing models which may be defined in pricing data 130. Pricing models for badges and other examples of collectible virtual goods may follow various pricing structures according to the constraints and expectations of the industry in which the model is deployed. One example of a pricing model which may be used by embodiments is a tiered pricing structure. A tiered pricing structure grants incentives to users who sign a creative entity early while the creative entity is still unknown. For example, the price structure might be as follows: the first 1,000 fans pay $0.99, then the next 9,000 fans pay $1.99, and thereafter the cost rises to $2.99. In an embodiment, each tier may be more expensive than the prior tier in the sequence. In this way, an early supporter of the creative entity is rewarded for their early support by paying a lower price for the collectible virtual good than subsequent purchasers.

In an embodiment, once a virtual good is purchased, the virtual good remains active indefinitely. In another embodiment, a purchased virtual good may expire after a particular period of time. The user may be able to reactive an expired virtual good for a reduced fee or at the original purchase price of the virtual good. Allowing virtual goods to be reactivated at the original purchase price provides an additional incentive to be an early purchaser of a virtual good.

The provider of platform 100 may take a commission for purchases of virtual goods, and the creative entity receives the remaining portion of the revenue. If virtual goods are purchased using a subscription model, then the provider of platform 100 may take a certain percentage of the subscription fee, and the creative entity may take the remaining portion of the subscription fee.

### Hardware Mechanisms

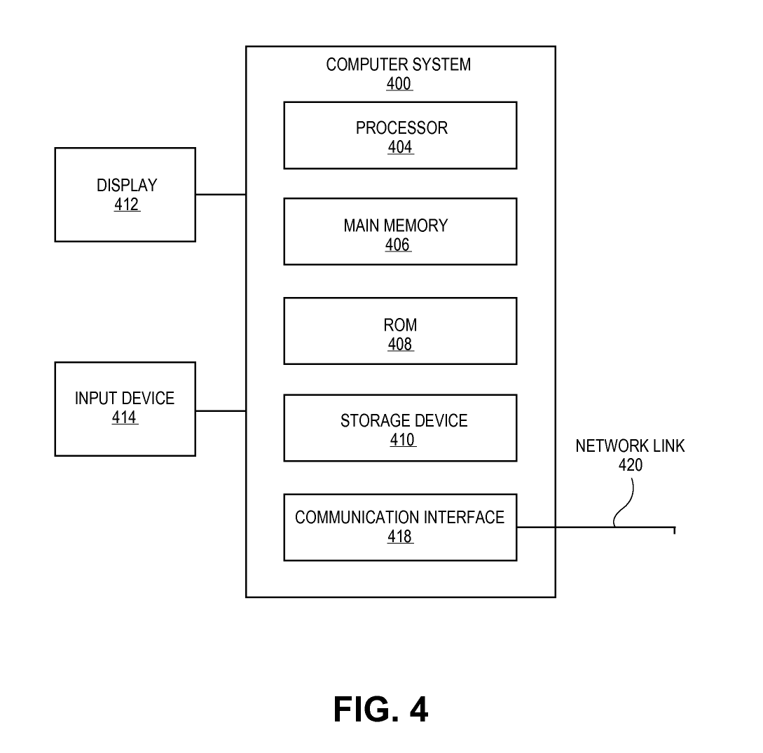

In an embodiment, platform 100 and clients 110, 112, and 114 of FIG. 1 may each be implemented on, include, or correspond to a computer system. FIG. 4 is a block diagram that illustrates a computer system 400 upon which an embodiment of the invention may be implemented. In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device for storing static information and instructions for processor 404. A storage device 410, such as a magnetic disk or optical disk, is provided for storing information and instructions.

Computer system 400 may be coupled to a display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments of the invention may include any number of input devices 414 coupled to computer system 400.

Embodiments of the invention are related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “computer-readable storage medium” as used herein refers to any tangible medium that participates in storing instructions which may be provided to processor 404 for execution. Such a medium may take many forms, including but not limited to, non-volatile media and volatile media. Non-volatile media includes, for example, optical or magnetic disks, such as storage device 410. Volatile media includes dynamic memory, such as main memory 406.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a network link 420 to computer system 400.

Communication interface 418 provides a two-way data communication coupling to a network link 420 that is connected to a local network. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through a local network to a host computer or to data equipment operated by an Internet Service Provider (ISP).

Computer system 400 can send messages and receive data, including program code, through the network(s), network link 420 and communication interface 418. For example, a server might transmit a requested code for an application program through the Internet, a local ISP, a local network, subsequently to communication interface 418. The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more computer readable mediums storing one or more sequences of instructions, which when executed by one or more processors, cause:
storing, at a content platform, tiered pricing data that defines, for each of a plurality of content producers, a sequence of tiers, wherein each tier in the sequence of tiers is associated with a different price and a particular number of virtual goods;
the content platform identifying a next available virtual good for a particular content provider based on how many virtual goods associated with the particular content provider have already been purchased; and
upon receiving payment, from the user, for a virtual good, the content platform providing ownership of the virtual good to the user to entitle the user to receive restricted content provided by the content producer associated with the virtual good,
wherein the visual appearance of the virtual good is based, at least in part, upon how many virtual goods of the content producer have already been purchased.

2. The one or more computer readable mediums of claim 1, wherein the particular content producer, and not the content platform, determines the composition of the restricted content.

3. The one or more computer readable mediums of claim 1, wherein the virtual good is a digital badge, and wherein the visual appearance of the digital badge is associated with the particular content provider.

4. The one or more computer readable mediums of claim 3, wherein the visual appearance of the badge includes a number that represents how many other users, prior to the user, purchased a virtual good associated with the particular content producer.

5. The one or more computer readable mediums of claim 1, wherein the price associated with each tier of the sequence of tier is a periodic subscription fee.

6. The one or more computer readable mediums of claim 5, wherein a first portion of the price associated with each tier of the sequence of tier is received by a provider of the content platform and a remaining portion of the price associated with each tier of the sequence of tier is received by the content producer.

7. The one or more computer readable mediums of claim 1, wherein execution of the one or more sequences of instructions further causes:
in response to receiving search criteria from the user, displaying a plurality of virtual goods associated with content producers having characteristics that match the search criteria.

8. The one or more computer readable mediums of claim 1, wherein execution of the one or more sequences of instructions further causes:
in response to receiving input from the user, displaying a set of virtual goods which the user may be interested in based upon an analysis of which virtual goods the user has already purchased.

9. The one or more computer readable mediums of claim 1, wherein execution of the one or more sequences of instructions further causes:
in response to receiving input from the user, displaying a bundle of virtual goods which the user may purchase as a single unit.

10. The one or more computer readable mediums of claim 1, wherein execution of the one or more sequences of instructions further causes:
in response to the user purchasing the next available virtual good, providing the user with access to purchase a set of restructured virtual goods, wherein the set of restricted virtual goods may only be purchased by users who have already purchased a virtual good.

11. The one or more computer readable mediums of claim 1, wherein the price associated with each tier of the sequence of tiers increases with sequence position within the sequence of tiers.

12. An apparatus, comprising:
One or more processors; and
One or more computer readable mediums storing one or more sequences of instructions, which when executed by the one or more processors, cause:
storing, at a content platform, tiered pricing data that defines, for each of a plurality of content producers, a sequence of tiers, wherein each tier in the sequence of tiers is associated with a different price and a particular number of virtual goods;
the content platform identifying a next available virtual good for a particular content provider based on how many virtual goods associated with the particular content provider have already been purchased; and
upon receiving payment, from the user, for a virtual good, the content platform providing ownership of the virtual good to the user to entitle the user to receive restricted content provided by the content producer associated with the virtual good,
wherein the visual appearance of the virtual good is based, at least in part, upon how many virtual goods of the content producer have already been purchased.

13. The apparatus of claim 12, wherein the particular content producer, and not the content platform, determines the composition of the restricted content.

14. The apparatus of claim 12, wherein the visual appearance of the virtual good includes a number that represents how many other users, prior to the user, purchased virtual goods associated with the particular content producer.

15. The apparatus of claim 12, wherein execution of the one or more sequences of instructions further causes:
in response to receiving input from the user, displaying a set of virtual goods which the user may be interested in based upon an analysis of which virtual goods the user has already purchased.

16. The apparatus of claim 12, wherein execution of the one or more sequences of instructions further causes:
in response to the user purchasing the next available virtual good, providing the user with access to purchase a set of restructured virtual goods, wherein the set of restricted virtual goods may only be purchased by users who have already purchased a virtual good.

17. A method for distributing content, comprising:
storing, at a content platform, tiered pricing data that defines, for each of a plurality of content producers, a sequence of tiers, wherein each tier in the sequence of tiers is associated with a different price and a particular number of virtual goods;
the content platform identifying a next available virtual good for a particular content provider based on how many virtual goods associated with the particular content provider have already been purchased; and
upon receiving payment, from the user, for a virtual good, the content platform providing ownership of the virtual good to the user to entitle the user to receive restricted content provided by the content producer associated with the virtual good,
wherein the visual appearance of the virtual good is based, at least in part, upon how many virtual goods of the content producer have already been purchased.

18. The method of claim 17, wherein the particular content producer, and not the content platform, determines the composition of the restricted content.

19. The method of claim 17, wherein the visual appearance of the virtual good includes a number that represents how many other users, prior to the user, purchased virtual goods associated with the particular content producer.

20. The method of claim 17, further comprising:
in response to receiving input from the user, displaying a set of virtual goods which the user may be interested in based upon an analysis of which virtual goods the user has already purchased.

21. The method of claim 17, further comprising:
in response to the user purchasing the next available virtual good, providing the user with access to purchase a set of restructured virtual goods, wherein the set of restricted virtual goods may only be purchased by users who have already purchased a virtual good.
